(19) United States
(12) Patent Application Publication
(10) Pub. No.: US 2013/0265598 A1
(43) Pub. Date: Oct. 10, 2013

(54) OFF-GRAY BALANCE CALIBRATION FOR EXTENDED COLOR GAMUT

(71) Applicant: Xerox Corporation, Norwalk, CT (US)

(72) Inventors: Patricia Joanne Donaldson, Pittsford, NY (US); Lalit Keshav Mestha, Fairport, NY (US); Tonya L. Love, Rochester, NY (US); Ta-Chen Hsu, San Gabriel, CA (US)

(21) Appl. No.: 13/897,781

(22) Filed: May 20, 2013

Related U.S. Application Data
(63) Continuation-in-part of application No. 12/466,445, filed on May 15, 2009, now abandoned.
(60) Provisional application No. 61/056,346, filed on May 27, 2008.

(51) Int. Cl. H04N 1/60

(52) U.S. Cl. CPC H04N 1/6027; H04N 1/6077
USPC 358/1.9

(57) ABSTRACT

A printing system and associated method is provided which is capable of operating in a standard output color gamut mode and/or a non-standard output color gamut mode. According to an exemplary method, the printing system non-standard output color gamut mode is associated with an off-gray balance calibration to extend the gamut of the printing system to include colors outside the gamut associated with the standard output color gamut mode.

This continuation-in-part application claims the priority benefit of U.S. provisional patent application No. 61/056,346, filed May 27, 2008, and utility patent application Ser. No. 12/466,445, filed May 15, 2009, the disclosure of which is incorporated herein by reference.

### TECHNICAL FIELD

The present disclosure generally relates to color management in printing and/or marking systems. In particular, the disclosure is directed to a method and/or system for off-gray balance calibration to improve color stability over time in a printing or marking device in which selectively modified process setpoints are optionally employed to extend an output color gamut of the device beyond its normal or nominal output color gamut, referred to herein as the “standard” output color gamut of the device. While the following disclosure generally makes reference to printers and/or printing, it is to be appreciated that the presently disclosed subject matter is equally applicable to other marking and/or image forming devices, such as copiers or other devices that form images, e.g., on an image-receiving medium.

### BACKGROUND

A typical process color printer or other like marking device commonly uses magenta (M), cyan (C), yellow (Y) and black (K) colorants or color separations in various amounts and/or combinations to achieve a range of colors. Usually, it is deemed desirable for the printer or other marking device to: (i) have a large output color gamut, (ii) be gray-balanced, and (iii) have stable color output over time.

Generally, the output color gamut of a printer can be described by a multi-dimensional space of a given volume with axes of the space being set or defined initially by the pigments, colorants and/or color separations used for the primary colors, e.g., such as M, Y, C and K. Commonly, in forming multi-color output images, for example with a xerographic process, each of the primary colors or colorants (e.g., toner) is deposited on an intermediate image-forming element (e.g., such as a photoreceptor) to develop a latent image thereon prior to being transferred to an image-receiving medium (e.g., such as paper). Any given output color is therefore defined by the interaction of the primary colorants, and the output color gamut of the printer is accordingly limited by a total amount of colorant in any combination that can be effectively deposited and/or transferred. Often, the amount of colorant deposited on the image-forming element is measured in terms of Developed Mass per unit Area (DMA). In this respect, the output color gamut of the printer depends not only upon the pigments used in the colorants, but also upon the total DMA achievable. For example, in a printer employing what is known as Image-On-Image (IOI) processing (e.g., such as the iGen3 digital production presses commercially available from Xerox), the total DMA achievable is generally limited by system interactions, e.g., such that the total DMA developed by all the color separations may be limited to less than approximately 1.2 mg/cm². Notably, the upper limit on DMA in this case is set by various limits imposed as a result of the IOI processing. Also, in a printer using an aqueous or xerographic process, the total DMA of the system may be limited by the ability to dry the paper, by paper cockle, or by offsetting in the fuser, if too much mass is deposited on the paper in some area(s). More generally, the DMA depends on the setpoints for certain process parameters of each of the color separations. These process parameters include, e.g., photoreceptor voltages (charges and/or discharged voltages), donor and/or magnetic roll voltages, toner concentrations, etc.

As stated above, it is commonly desirable for a printer or other marking device to be gray-balanced. One approach to achieving the desired gray-balance is to calibrate the printer to a gray or neutral aim or target curve in color space and generate a tone reproduction curve (TRC) for each of the respective color separations, such that when input digital amounts of the respective color separations are substantially equal to one another (i.e., M=Y=C), then the resulting output has a substantially neutral or gray tint. However, over time, the output of a conventional printer or marking device may drift or otherwise deviate from predetermined optimums due to various factors, e.g., such as environmental conditions (i.e., temperature, relative humidity, etc.), use patterns, the type of media used (e.g., different paper types and paper batches, transparencies, etc.), variations in the media, variations from original models used in initialization of the device, general wear, etc.

Accordingly, to maintain the desired gray-balance and/or corresponding color stability over time, a suitable calibration process is run frequently or as otherwise desired to update the respective gray-balance TRCs. Examples of known gray-balance calibration techniques are disclosed in Mestha, et al., “Gray Balance Control Loop for Digital Color Printing Systems,” published in the proceedings of IS&T's “The 21st International Congress on Digital Printing Technologies (NIP21),” Sep. 18-23, 2005, Baltimore, Md., and U.S. Pat. No. 7,307,752 to Mestha, et al., incorporated by reference herein in their entirety.

Notwithstanding the foregoing, a user may from time-to-time desire to produce an output color which is outside the standard output color gamut available on a given printer or marking device, i.e., as constrained by the colorants/pigments used and/or the current nominal DMA for the device. For example, a user may want to produce an output color having a particular highly saturated hue (e.g., a highly saturated red or other hue) because it is in or part of a corporate logo or other important element of an image to be produced or reproduced. As can be appreciated, this color nevertheless may not be within the standard output color gamut producible by the device as defined by the colorants or pigments employed and the nominal process setpoints, e.g., which constrain the DMA of the device. However, a desired color outside the standard output color gamut of the device may still be achievable, e.g., by altering the DMA of one or more of the colorants (e.g., to produce a highly saturated red by increasing the M and Y DMA). In practice, this can be achieved by allowing a user to modify selected process setpoints, e.g., to shift the output color gamut in a desired direction in color space or otherwise alter the output color gamut from the norm or standard for that device. Methods and/or systems for producing colors outside the normal or standard output color gamut of a device are disclosed, for example, in Mestha, et al., U.S. patent application Ser. No. 11/099,589, filed Apr. 6, 2005, and Mestha, et al., U.S. patent application entitled “Spot Color Printing With Non-Standard Gamuts Achieved With Process Setpoint Adjustment,” patent application Ser. No. 12/127,675, filed May 27, 2008, incorporated by reference herein in their entirety.

However, because of system interactions, e.g., in a device employing IOI processing, extending the DMA of one colorant or color separation will generally decrease the DMA of another colorant or color separation, thereby throwing the printer or other marking device out of gray balance. For example, considering a device in which the color separations are processed in MYCK order, the addition of more magenta or extension of the magenta DMA to improve the output red gamut will generally decrease the cyan developed mass, thereby throwing the printer or other marking device out of gray balance, and in accordance with conventional architectures, the desire to maintain gray balance significantly constrains the magenta mass (at least in this example) and thereby limits the output color gamut in the red. Ultimately, some users may be dissatisfied with the resulting red gamut. Of course, in alternate examples where devices process color separations in other orders and/or users desired other particular colors outside the standard output color gamut of a device, similar results and/or dissatisfaction can be experienced.

Nevertheless, as pointed out above, system gray-balance and/or corresponding color stability may be returned in normal fashion by calibrating the printer or other marking device so that input equal digital amounts of the employed color separations (i.e., M=Y=C) gives an output neutral or gray tint. However, trying to perform such gray-balance calibration, while the printer or other marking device is operating or set to operate with modified process setpoints that have been selected to provide for an output color which is outside the normal or nominal output color gamut of the device (i.e., while the output color gamut of the printer or other marking device has been intentionally shifted in a desired direction in color space or otherwise altered from the norm or standard), can introduce certain image quality defects. Accordingly, either gray-balance can be abandoned in shadow regions of an image being produced/reproduced (i.e., regions with densities near solid), which leaves such regions with an off-neutral hue (e.g., with a reddish hue), or the maximum digital area coverage of a particular color separation (e.g., magenta) can be set so that when a user calls for a solid patch of that color separation, then the printer or other marking device employs a halftone. These solutions, however, are not entirely satisfactory. In particular, abandoning gray balance in the shadow regions can lead to other image quality artifacts, e.g., such as contouring, where steps in density are visible in a color gradient sweep. And, halftoning solid patches of a given color separation generally decreases the gamut available, and negatively impacts the benefit achieved by increasing the DMA of the respective color separation in the first place.

Accordingly, there is disclosed herein a method and/or system which overcomes the above referenced problems and/or others by providing off-gray balance calibration in a printing or marking device in which selectively modified process setpoints are optionally employed to extend an output color gamut of the device beyond its standard output color gamut.

### BRIEF DESCRIPTION

In one embodiment of this disclosure, described is a method of performing an off-gray balance calibration of a printing system to print a non-standard gamut of colors, the printing system including an operator selectable non-standard gamut mode of operation associated with the off-gray balance calibration of the printing system and a standard gamut mode of operation associated with a gray balance calibration of the printing system, the method comprising: a) the printing system selectably operating in the non-standard gamut mode; b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system; c) the printing system printing a color sample set including a plurality of patches representing the gamut associated with the operator modified one or more setpoints for the one or more process parameters associated with modifying the gamut; d) the printing system generating one or more color look-up tables associated with the operator modified one or more setpoints for the one or more process parameters, and the printing system storing a set of measured color space values associated with a subset of the printed plurality of patches associated with an axis of constant hue; e) repeating steps b)-d), if necessary, until a final color sample set is selected by the user, the final color sample set associated with a final one or more color look-up tables and a final set of measured color space values; and f) the printing system associating the final one or more color look-up tables and the final set of stored measured color space values with the non-standard gamut mode, the final one or more color look-up tables associated with processing image data to be printed using the non-standard gamut.

In another embodiment of this disclosure, described is a method of printing an image on a printing system, the printing system including an operator selectable non-standard gamut mode of operation associated with an off-gray balance calibration of the printing system and a standard gamut mode of operation associated with a gray balance calibration of the printing system, the method comprising: an operator selectably placing the printing system in the non-standard gamut mode of operation; and the printing system printing image data associated with an image source while operating in the non-standard gamut mode of operation, wherein the printing system accesses off-gray balance calibration data to process the image data, the off-gray balance calibration data generated by a method comprising: a) the printing system selectably operating in the non-standard gamut mode; b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system; c) the printing system printing a color sample set including a plurality of patches representing the gamut associated with the operator modified one or more setpoints for the one or more process parameters associated with modifying the gamut; d) the printing system generating one or more color look-up tables associated with the operator modified one or more setpoints for the one or more process parameters, and the printing system storing a set of measured color space values associated with a subset of the printed plurality of patches associated with an axis of constant hue; e) repeating steps b)-d), if necessary, until a final color sample set is selected by the user, the final color sample set associated with a final one or more color look-up tables and a final set of measured color space values; and f) the printing system associating the final one or more color look-up tables and the final set of stored measured color space values with the non-standard gamut mode, the final one or more color look-up tables associated with processing image data to be printed using the non-standard gamut.

In still another embodiment of this disclosure, described is a method of performing an off-gray balance calibration of a printing system to print a non-standard gamut of colors, the printing system including an operator selectable non-standard gamut mode of operation associated with the off-gray balance calibration of the printing system and a standard gamut mode of operation associated with a gray balance calibration of the printing system, the method comprising: a) the printing system selectably operating in the non-standard gamut mode; b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system; c) the printing system printing a color sample set including a plurality of patches representing the gamut associated with the operator modified one or more setpoints for the one or more process parameters associated with modifying the gamut; d) the printing system generating one or more color look-up tables associated with the operator modified one or more setpoints for the one or more process parameters, and the printing system storing a set of measured color space values associated with a subset of the printed plurality of patches associated with substantially equivalent process values of colorants associated with the printing system; e) repeating steps b)-d), if necessary, until a final color sample set is selected by the user, the final color sample set associated with a final one or more color look-up tables and a final set of measured color space values; and f) the printing system associating the final one or more color look-up tables and the final set of stored measured color space values with the non-standard gamut mode, the final one or more color look-up tables associated with processing image data to be printed using the non-standard gamut.

In yet another embodiment of this disclosure, described is a method of printing an image on a printing system, the printing system including an operator selectable non-standard gamut mode of operation associated with an off-gray balance calibration of the printing system and a standard gamut mode of operation associated with a gray balance calibration of the printing system, the method comprising: an operator selectably placing the printing system in the non-standard gamut mode of operation; and the printing system printing image data associated with an image source while operating in the non-standard gamut mode of operation, wherein the printing system accesses off-gray balance calibration data to process the image data, the off-gray balance calibration data generated by a method comprising: a) the printing system selectably operating in the non-standard gamut mode; b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system; c) the printing system printing a color sample set including a plurality of patches representing the gamut associated with the operator modified one or more setpoints for the one or more process parameters associated with modifying the gamut; d) the printing system generating one or more color look-up tables associated with the operator modified one or more setpoints for the one or more process parameters, and the printing system storing a set of measured color space values associated with a subset of the printed plurality of patches associated with substantially equivalent process values of colorants associated with the printing system; e) repeating steps b)-d), if necessary, until a final color sample set is selected by the user, the final color sample set associated with a final one or more color look-up tables and a final set of measured color space values; and f) the printing system associating the final one or more color look-up tables and the final set of stored measured color space values with the non-standard gamut mode, the final one or more color look-up tables associated with processing image data to be printed using the non-standard gamut.

### BRIEF DESCRIPTION OF THE DRAWINGS

FIG. 1 is a box diagram illustrating an exemplary printer or other like marking device suitable for practicing aspects of the presently disclosed subject matter.

FIG. 2 is a flow chart of a method of printing an image using an off-gray balance calibration according to an exemplary embodiment of this disclosure.

FIG. 3 is a flow chart of another method of printing an image using an off-gray balance calibration according to an exemplary embodiment of this disclosure.

### DETAILED DESCRIPTION

Generally, the present specification discloses a method and/or system, for use in connection with a printer or other marking device, in which off-gray balance calibration is performed when the printer or marking device is operating or set to operate in a “non-standard” output color gamut mode (or non-standard-gamut (NSG) mode for short), i.e., where the otherwise normal or nominal output color gamut of the device has been shifted or extended in a desired direction in color space or otherwise altered from the norm of the device (e.g., by modifying or altering selected process setpoints) to allow the device to output one or more particular colors that otherwise would lie outside the standard output color gamut of the device. Conversely, when the printer or marking device is operating or set to operate in a “standard” output color gamut mode (or standard-gamut (SG) mode for short), i.e., where the normal or nominal output color gamut of the device is being employed for the output being produced/reproduced (e.g., by employing the nominal or default process setpoints), then the presently disclosed method and/or system optionally provides for the performance of a conventional gray-balance calibration.

Suitably, the aforementioned NSG mode of operation is optionally implemented in accordance with the teachings of Mestha et al., U.S. patent application Ser. No. 11/099,589, filed Apr. 6, 2005, and/or Mestha et al., U.S. patent application entitled “Spot Color Printing With Non-Standard Gamuts Achieved With Process Setpoint Adjustment,” application Ser. No. 12/127,675, filed May 27, 2008, and the gray-balance calibration is optionally implemented in accordance with the teachings of Mestha, et al., “Gray Balance Control Loop for Digital Color Printing Systems,” published in the proceedings of IS&T's “The 21st International Congress on Digital Printing Technologies (NIP21),” Sep. 18-23, 2005, Baltimore, Md., and/or U.S. Pat. No. 7,307,752 to Mestha, et al.

In one optional embodiment, the off-gray balance calibration is also performed in a similar fashion to the gray-balance calibration. However, in the off-gray balance calibration process, the aim or target colors or aim or target curve employed in the calibration process does not substantially correspond with a gray or neutral tint or gray or neutral axis in the output color space. Rather, the aim or target colors and/or the aim or target curve are selected to have a substantially non-neutral tint or correspond to a substantially off-gray axis. In other words, when the normal gray-balance calibration is performed, the printer or marking device is calibrated to a normal gray-balance axis, i.e., such that when input digital amounts of the respective color separations are substantially equal to one another (i.e., M=Y=C), then the resulting output has a substantially neutral or gray tint. Alternately, when the off-gray balance calibration is performed, the printer or marking device is calibrated to a different substantially off-gray axis, i.e., such that when input digital amounts of the respective color separations are substantially equal to one another (i.e., M=Y=C), then the resulting output has a substantially off-gray or non-neutral tint or hue, e.g., in accordance with the direction in color space in which the otherwise normal or nominal output color gamut of the device has been shifted or extended due to operation of the device in the NSG mode. For example, when the output color gamut of the device is shifted or altered from its standard (e.g., to allow for the production of a normally out-of-gamut red), as may be achieved by selecting process setpoints that result in higher than usual magenta DMA, then the aim curve and/or target colors employed in the off-gray balance calibration process are optionally selected to have a reddish hue. Similarly, if a set of modified process setpoints is used which results in a lower than usual magenta DMA and a higher than usual cyan DMA (e.g., thereby shifting or altering the standard output color gamut of the device to allow for the production of a normally out-of-gamut blue), then the off-gray balance calibration may optionally employ an aim curve and/or target colors which have a blueish hue.

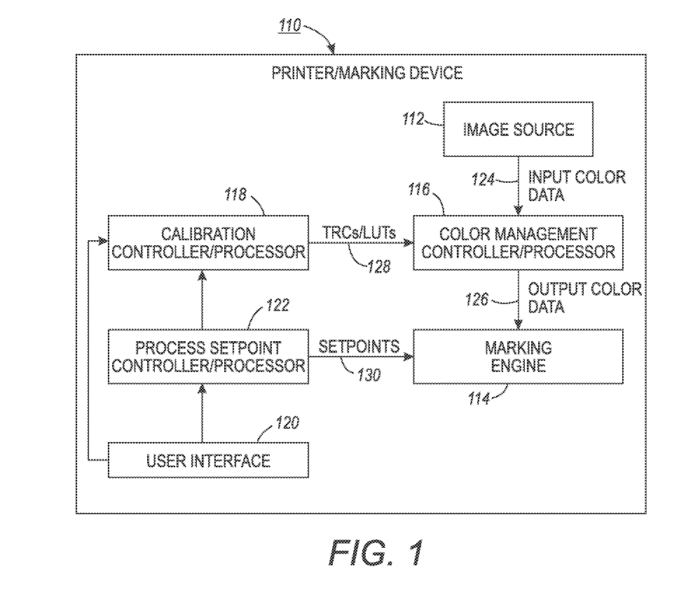

More specifically, with reference to FIG. 1, there is shown a color printer or other like marking device 110 that produces or reproduces a corresponding output color image from input color image data. In suitable embodiments, for example, the device 110 may be a printer, a copier, a facsimile machine, etc. In any event, suitably, the device 110 is a digital color device.

As shown, the device 110 includes an image source 112 from which input image data (e.g., digital image data) is received or otherwise obtained. Suitably, the input image data from the source 112 includes color data and/or values that describe or otherwise define the particular colors of respective elements (e.g., pixels) of an input image. Optionally, the image source 112 may be a scanner that produces input image data from a scanned hardcopy or other like input, a data storage device containing a digital or other image, a digital or other suitable camera (still or video), a locally or remotely located computer or the like which provides the input image data, a facsimile receiver, etc.

In the illustrated embodiment, the device 110 also includes a marking engine 114 or other like image output device. Suitably, the marking engine 114 applies colorants (e.g., toner, ink, etc.) to an image-receiving medium (e.g., paper, transparency, etc.) in accordance with received image data to produce or reproduce an output image corresponding to the input image data. More specifically, the colorants employed by the marking engine 114 to output the respective color image optionally include a plurality of particular pigments and/or color separations, e.g., magenta (M), cyan (C), yellow (Y) and black (K). That is to say, suitably, the marking engine 114 uses various amounts and/or combinations of magenta (M), cyan (C), yellow (Y) and black (K) colorants or color separations to achieve a range of output colors. Accordingly, the standard output color gamut of the device 110 can be in part generally described by a multi-dimensional space of a given volume with axes of the space being set or defined initially by the pigments, colorants and/or color separations used for the primary colors, e.g., such as M, Y, C and K.

Optionally, the marking engine 114 is a xerographic device that employs an intermediate image-forming element (e.g., such as a photoreceptor) onto which a latent image is developed by depositing the colorants thereon prior to the colorants being transferred from the intermediate image-forming element to the image-receiving medium. In particular, the marking engine 114 optionally employs an IOI process whereby the plurality of colorants and/or color separations are deposited and/or developed in overlapping or superimposed fashion on the intermediate image-forming element. Accordingly, any given color produced by the marking engine 114 is therefore defined by the interaction of the primary colorants, and the output color gamut of the device 110 is accordingly limited by a total amount of colorant in any combination that can be effectively deposited and/or transferred.

As shown in FIG. 1, the device 110 also includes a color management controller and/or processor 116 (i.e., color manager (CM) for short). Suitably, the CM 116 parses the input image data and/or otherwise obtains input color data 124 and/or values therefrom and corrects or otherwise adjusts the same (e.g., in accordance with particular TRCs, color look-up-tables (LUTs) and/or other appropriate color transforms) 128 to generate output color data and/or values supplied to the marking engine 114 for production of the output image 126. More specifically, the TRCs and/or LUTs are optionally provided to the CM 116 and/or updated by a calibration controller and/or processor 118 that regulates and/or selectively performs a gray-balance or off-gray balance calibration process for the device 110 depending upon the current operating mode of the device 110, i.e., either SG mode or NSG mode, respectively.

Suitably, the device 110 is also equipped or otherwise provisioned with a user interface (UI) 120 that may be selectively employed by a user to choose an operating mode and/or otherwise control operation of the device 110. For example, via the UI 120, an operator or user may select a particular color rendition dictionary (CRD) from among a plurality of such CRDs provisioned in and/or for the device 110. Each particular CRD is suitably associated with a specific set of particular process setpoints 130 corresponding to process parameters regulating the operation and/or functioning of the marking engine 114. For example, the process setpoints correspond to parameters for the photoreceptor voltage (charged and/or discharged), donor and/or magnetic roll voltages, toner concentrations and the like. Alternately, the UI 120 may allow a user or operator to selectively alter or modify any one or more of the individual process setpoints. In any event, optionally one CRD and/or combination of process setpoints (referred to herein as the standard or default CRD and/or the standard or default process setpoints) corresponds to the SG mode of operation of the device 110. That is to say, when the standard CRD (e.g., the default CRD) is selected or the process setpoints are left in their default or normal state, then the device 110 is set to operate in SG mode, i.e., with the standard output color gamut of the device 110 being available for producing/reproducing an output image. Alternately, when a non-standard or alternate CRD (e.g., different from the default CRD) is selected or the process setpoints are modified or altered from their default or normal state, then the device 110 is set to operate in NSG mode, i.e., with an output color gamut being available that is shifted or extended in a desired direction in color space or otherwise altered from the standard output color gamut, e.g., to allow production of a color in the output image which would otherwise normally reside outside of the standard output color gamut of the device 110.

Suitably, as shown in FIG. 1, a process setpoint controller and/or processor 122 sets and/or provides selected process setpoints to the marking engine 114 which in turn operates and/or functions in accordance therewith. In this manner, by selectively setting, modifying and/or otherwise providing selected process setpoints to the marking engine 14, the process setpoint controller/processor 122 is able to achieve a selective shift or extension or other alteration of the output color gamut of the device 110 from the standard output color gamut. For example, since the output color gamut of the device 110 depends at least partially upon the DMA of the respective color separations which in turn can be altered by changing the process setpoints, the setpoint controller/processor 122 is capable of selectively altering the output color gamut of the device 110. Optionally, the setpoint controller/processor 122 selects or otherwise selectively modifies particular process setpoints that are provided to the marking engine 114 in accordance with the CRD selected via the UI 120 and/or in accordance with particular setpoint values selected via the UI 120. Alternately, the process setpoints are selected and/or modified based upon other control input received by the setpoint controller/processor 122.

In one exemplary embodiment, the calibration controller/processor 118 controls and/or performs a calibration process for the device 110. Suitably, either a gray-balance or off-gray balance calibration is selected by the calibration controller/processor 118 depending on the operational mode of the device 110. In particular, if the device 110 is operating in the SG mode (i.e., if the default or standard CRD has been selected or the process setpoints are set to their default or standard or normal values (e.g., via appropriate manipulation of the UI 120 or otherwise) or if the device 110 is otherwise set to operate using its standard output color gamut), then a conventional gray-balance calibration is selected, and in turn performed at the appropriate time. Alternately, if the device 110 is operating in the NSG mode (i.e., if an alternate CRD (e.g., different from the standard or default CRD) has been selected or the process setpoints are modified or altered from the default or standard or normal values (e.g., via appropriate manipulation of the UI 120 or otherwise) or if the device 110 is otherwise set to operate using an output color gamut that has been shifted or extended in a desired direction in color space or which has otherwise been altered from the standard or norm (e.g., to allow for the output production of one or more specific colors which would otherwise normally lie outside the standard output color gamut of the device 110)), then an off-gray balance calibration is selected, and in turn performed at the appropriate time.

Optionally, the calibration controller/processor 118 determines or recognizes the operational state of the device 110 based upon input or other indications of the same received or obtained by the calibration controller/processor 118, e.g., from either or both the UI 120 and/or the process setpoint controller/processor 122. For example, the particular mode, CRD and/or process setpoint selections (e.g., entered via the UI 120 or otherwise established) are optionally communicated to the calibration controller/processor 118, and based thereon the calibration controller/processor 118 can: (i) determine the type of calibration to select and/or perform (i.e., either gray-balance calibration or off-gray balance calibration), and/or (ii) optionally further regulate the calibration process—i.e., in accordance with and/or depending upon the recognized operational mode (e.g., NSG or SG) and/or the selected process setpoint parameters and/or the otherwise established output color gamut (e.g., the standard output color gamut or a shifted or extended or otherwise altered or modified output color gamut). Alternately, the various process setpoint values may be communicated from the process setpoint controller/processor 122 to the calibration controller/processor 118. In any event, upon selecting and completing the appropriate calibration process, TRCs, color LUTs and/or other like suitable transforms are generated and/or updated in accordance therewith. In turn the generated TRCs, color LUTs and/or other transforms or corresponding updates thereto are provided to the CM 116 that performs color corrections, adjustments and/or other appropriate color processing using the provided and/or updated TRCs, color LUTs and/or other transforms.

More specifically, when gray-balance calibration is called for, the TRCs, color LUTs and/or other transforms are generated or updated so that when digital input color values or data (e.g., received by the CM 116) are defined or can be represented by substantially equal amounts of the respective color separations (i.e., M=Y=C), then the resulting output has a substantially neutral or gray tint. Suitably, the gray-balance calibration is optionally implemented in accordance with the teachings of Mestha, et al., “Gray Balance Control Loop for Digital Color Printing Systems,” published in the proceedings of IS&T's “The 21st International Congress on Digital Printing Technologies (NIP21),” Sep. 18-23, 2005, Baltimore, Md., and/or U.S. Pat. No. 7,307,752 to Mestha, et al.

Alternately, when off-gray balance calibration is called for, the TRCs, color LUTs and/or other transforms are generated or updated so that when digital input color values or data (e.g., received by the CM 116) are defined or can be represented by substantially equal amounts of the respective color separations (i.e., M=Y=C), then the resulting output has a particular non-neutral or off-gray tint. Optionally, the off-gray balance calibration is achieved by altering the target colors or aim curve in the calibration process from neutral colors or a gray axis in color space (e.g., as would be used in gray-balance calibration) to specific non-neutral colors and/or a particular off-gray axis in color space. For example, when the output color gamut of the device is shifted or altered from its standard (e.g., to allow for the production of a normally out-of-gamut red), as may be achieved by selecting process setpoints that result in higher than usual magenta DMA, then the aim curve and/or target colors employed in the off-gray balance calibration process are optionally selected to have a reddish hue. Similarly, if a set of modified process setpoints is used which results in a lower than usual magenta DMA and a higher than usual cyan DMA (e.g., thereby shifting or altering the standard output color gamut of the device to allow for the production of a normally out-of-gamut blue), then the off-gray balance calibration may optionally employ an aim curve and/or target colors which have a bluish hue. Otherwise, the off-gray balance calibration may be executed and/or implemented in substantially the same manner as the gray-balance calibration.

In one suitable embodiment, where the input color data is defined in terms of device independent parameters, such as L*a*b* values, optionally, the CM 116 employs color LUTs or other suitable transforms (e.g., generated and/or updated by the performed calibration process) that map the L*a*b* values to appropriate CMYK quantities to provide the desired output color in accordance with the executed calibration. Alternately, where the input color data is defined in terms CMYK values, optionally, the CM 116 employs 4-4 CMYK to CMYK transforms (e.g., generated and/or updated by the performed calibration process) that map input CMYK values to appropriate output CMYK quantities to provide the desired output color in accordance with the executed calibration.

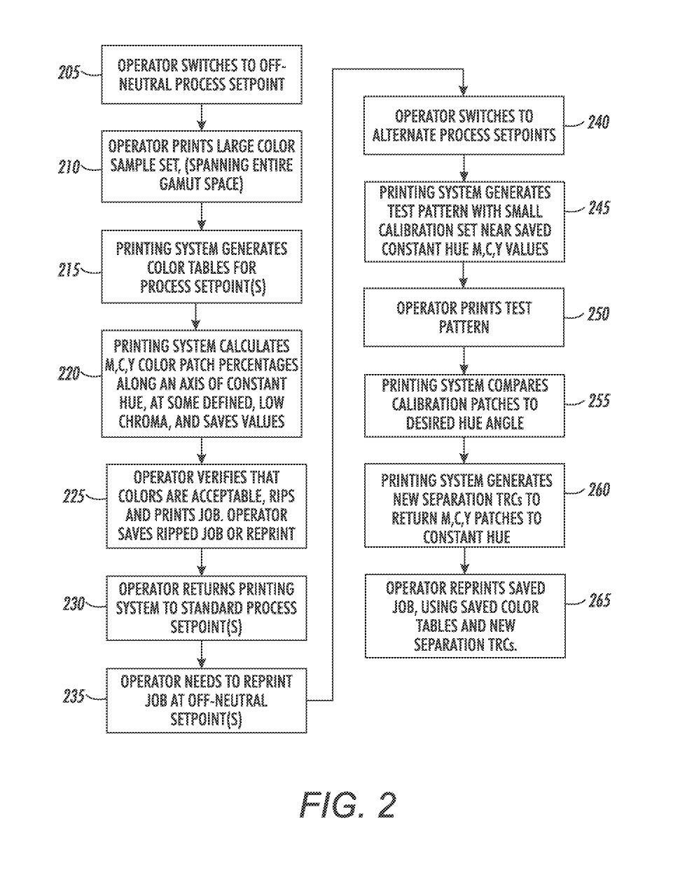

With reference to FIG. 2, illustrated is a flow chart of a method of printing an image using an off-gray balance calibration according to an exemplary embodiment of this disclosure. Specifically, FIG. 2 illustrates a method including the calibration of a printing system according to an axis of constant hue, associated with an off-gray balance, whereby the calibration of the printing system to the axis of constant hue provides a printable gamut extending beyond the gamut achievable during a gray balanced calibration of the printing system.

Operator switches to off-neutral process setpoint 205.

Operator prints large color sample set, spanning entire gamut space 210.

Printing system generates color tables for process setpoint 215.

Printing system calculates M, C, Y color patch percentages along an axis of constant hue, at some defined, low chroma, and saves values 220.

Operator verifies that colors are acceptable, RIPS and prints job. Operator saves ripped job for reprint 225.

Operator returns printing system to standard process setpoints 230.

Operator needs to reprint job at off-neutral setpoint 235.

Operator switches to alternate process setpoints 240.

Printing System generates test pattern with small calibration set near saved constant hue M, C, Y values 245.

Operator prints test pattern 250.

Printing System compares calibration patches to desired hue angle 255.

Printing System generates new separation TRCs to return M, C, Y patches to constant hue 260.

Operator reprints saved job, using saved color tables and new separation TRCs 265.

The primary benefit of calibration is that it allows us to return a printer to the state it was in when the color tables were generated, by adjusting only the single separation TRCs, bypassing the need to generate a completely new set of color tables. Generating new color tables (4×4 or 3×4 lookup tables covering all of color space) is expensive, while generating a calibration set along a single axis of constant C=M=Y or constant hue is relatively cheap. Calibrating the printer along an axis of constant hue may be preferable if there is a particular hue that the customer is concerned about (i.e. a logo color), however it would require generating the test pattern including the required M,Y,C values necessary to get a given hue after the color table was generated, which could mean generating the test patterns in the printer. In this case, the test pattern for a printer which has been setup for a larger red gamut could be different from the test pattern required for a more bluish gamut.

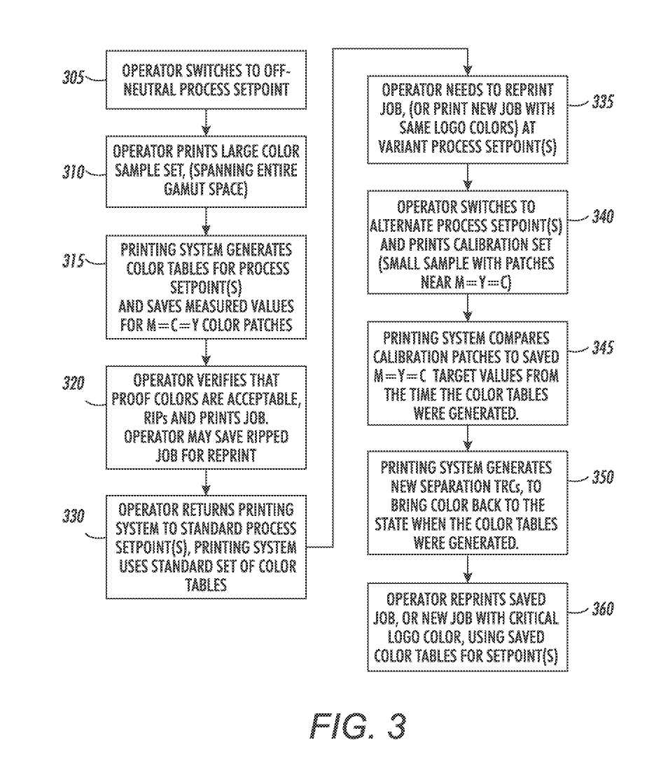

With reference to FIG. 3, illustrated is a flow chart of another method of printing an image using an off-gray balance calibration according to an exemplary embodiment of this disclosure. Specifically, FIG. 3 illustrates a method including the calibration of the printing system according to a process whereby the printing system setpoints are modified to provide a non-standard gamut and the printing system is calibrated based on a plurality of stored color space values associated with substantially equivalent process values, i.e. digital values, of colorants associated with the modified setpoints.

Operator switches to off-neutral process setpoint 305.

Operator prints large color sample set, (spanning entire gamut space) 310.

Machine, i.e. printing system, generates color tables for process setpoint and saves measured values for M=C=Y color patches 315, for example in L*a*b* or L*C*h* color space.

Operator verifies that proof colors are acceptable, RIPs and prints job. Operator may save ripped job for reprint 320.

Operator returns printing system to standard process setpoints. Printing System uses standard set of color tables 330.

Operator needs to reprint job, (or print new job with same logo colors) at variant process setpoint 335.

Operator reprints saved job, or new job with critical logo color, using saved color tables for setpoint 340.

Operator switches to alternate process setpoints and prints calibration set (small sample with patches near M=Y=C) 345.

Printing System compares calibration patches to saves M=Y=C target values from the time the Color tables were generated 350.

Printing System generates new separation TRCs, to bring color back to the state when the color tables were generated 360.

Optionally, the printing system can fault on calibration at step 350 if the calibration patches printed are too far from the saved M=Y=C target values. In this case, an operator is required to regenerate color look-up tables.

Using M=C=K values, rather than the previous method using constant hue values, allows the test pattern used for calibration to be generated once, and used for any modification in the process setpoints, i.e. a shift in process setpoints leading to a generally reddish hue would use the same test pattern as a setpoint which gave a bluish hue. The printer would return to a point with equal input M=Y=C to whatever the saved color values were.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of performing an off-gray balance calibration of a printing system to print a non-standard gamut of colors, the printing system including an operator selectable non-standard gamut mode of operation associated with the off-gray balance calibration of the printing system and a standard gamut mode of operation associated with a gray balance calibration of the printing system, the method comprising:
a) the printing system selectably operating in the non-standard gamut mode;
b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system;
c) the printing system printing a color sample set including a plurality of patches representing the gamut associated with the operator modified one or more setpoints for the one or more process parameters associated with modifying the gamut;
d) the printing system generating one or more color look-up tables associated with the operator modified one or more setpoints for the one or more process parameters, and the printing system storing a set of measured color space values associated with a subset of the printed plurality of patches associated with an axis of constant hue;
e) repeating steps b)-d), if necessary, until a final color sample set is selected by the user, the final color sample set associated with a final one or more color look-up tables and a final set of measured color space values; and
f) the printing system associating the final one or more color look-up tables and the final set of stored measured color space values with the non-standard gamut mode, the final one or more color look-up tables associated with processing image data to be printed using the non-standard gamut.

2. The method of performing an off-gray balance calibration of a printing system according to claim 1, further comprising:
g) the printing system selectably operating in the standard gamut mode;
h) the printing system selectably operating in the non-standard gamut mode, the non-standard gamut mode associated with the final one or more color look-up tables generated in step d) and the final set of stored measured color space values associated with the subset of the printed plurality of patches associated with an axis of constant hue;
i) the printing system printing a calibration set of patches associated with the axis of constant hue;
j) measuring and comparing the printed calibration set of patches to the final set of stored measured color space values generated in step d); and
k) generating colorant separation TRCs (Tone Reproduction Curves) to process the calibration set of patches such that the printed calibration set of patches substantially matches the final set of stored measured color space values generated in step d).

3. The method of performing an off-gray balance calibration of a printing system according to claim 1, wherein the standard gamut associated with the standard gamut mode is shifted along one or more gamut axes to generate the non-standard gamut.

4. The method of performing an off-gray balance calibration of a printing system according to claim 3, wherein the standard gamut is shifted by a predetermined axis of constant hue.

5. A method of printing an image on a printing system, the printing system including an operator selectable non-standard gamut mode of operation associated with an off-gray balance calibration of the printing system and a standard gamut mode of operation associated with a gray balance calibration of the printing system, the method comprising:
an operator selectably placing the printing system in the non-standard gamut mode of operation; and
the printing system printing image data associated with an image source while operating in the non-standard gamut mode of operation,
wherein the printing system accesses off-gray balance calibration data to process the image data, the off-gray balance calibration data generated by a method comprising:
a) the printing system selectably operating in the non-standard gamut mode;
b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system;
c) the printing system printing a color sample set including a plurality of patches representing the gamut associated with the operator modified one or more setpoints for the one or more process parameters associated with modifying the gamut;
d) the printing system generating one or more color look-up tables associated with the operator modified one or more setpoints for the one or more process parameters, and the printing system storing a set of measured color space values associated with a subset of the printed plurality of patches associated with an axis of constant hue;
e) repeating steps b)-d), if necessary, until a final color sample set is selected by the user, the final color sample set associated with a final one or more color look-up tables and a final set of measured color space values; and
f) the printing system associating the final one or more color look-up tables and the final set of stored measured color space values with the non-standard gamut mode, the final one or more color look-up tables associated with processing image data to be printed using the non-standard gamut.

6. The method of printing an image according to claim 5, wherein a user interface is configured to perform at least one of receiving text data, parsing text data, selecting an operating mode, controlling the operation of the printing system, selecting a color rendition dictionary, and altering or modifying setpoints.

7. The method of printing an image according to claim 5, wherein the one or more setpoints include process parameters which regulate operational hardware associated with the printing system.

8. The method of printing an image according to claim 7, wherein the one or more setpoints include one or more of a photoreceptor charged voltage, a photoreceptor discharge voltage, toner concentration, donor roll voltage and magnetic roll voltage.

9. The method of printing an image according to claim 5, wherein the image source includes at least one of color data, pixel data, scanner image data, digital camera data, video data and fax data.

10. The method of printing an image according to claim 5, wherein the printing system includes an intermediate photoreceptor member upon which colorants are deposited and subsequently transferred from the photoreceptor member to a media.

11. The method of printing an image according to claim 5, wherein the colorants include one of toner and ink including any combination of magenta, cyan, yellow and black.

12. The method of printing an image according to claim 5, wherein the non-standard output color gamut includes a shifting of the standard output color gamut to a region including colors outside the standard output color gamut.

13. A method of performing an off-gray balance calibration of a printing system to print a non-standard gamut of colors, the printing system including an operator selectable non-standard gamut mode of operation associated with the off-gray balance calibration of the printing system and a standard gamut mode of operation associated with a gray balance calibration of the printing system, the method comprising:
a) the printing system selectably operating in the non-standard gamut mode;
b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system;
c) the printing system printing a color sample set including a plurality of patches representing the gamut associated with the operator modified one or more setpoints for the one or more process parameters associated with modifying the gamut;
d) the printing system generating one or more color look-up tables associated with the operator modified one or more setpoints for the one or more process parameters, and the printing system storing a set of measured color space values associated with a subset of the printed plurality of patches associated with substantially equivalent process values of colorants associated with the printing system;
e) repeating steps b)-d), if necessary, until a final color sample set is selected by the user, the final color sample set associated with a final one or more color look-up tables and a final set of measured color space values; and
f) the printing system associating the final one or more color look-up tables and the final set of stored measured color space values with the non-standard gamut mode, the final one or more color look-up tables associated with processing image data to be printed using the non-standard gamut.

14. The method of performing an off-gray balance calibration of a printing system according to claim 13, further comprising:
g) the printing system selectably operating in the standard gamut mode;
h) the printing system selectably operating in the non-standard gamut mode, the non-standard gamut mode associated with the final one or more color look-up tables generated in step d) and the final set of stored measured color space values associated with the subset of the printed plurality of patches associated with substantially equivalent process values of colorants generated in step d);
i) the printing system printing a calibration set of patches associated with substantially equivalent process values of colorants associated with the printing system;
j) measuring and comparing the printed calibration set of patches to the final set of stored measured color space values generated in step d); and
k) generating colorant separation TRCs (Tone Reproduction Curves) to process the calibration set of patches such that the printed calibration set of patches substantially matches the final set of stored measured color space values generated in step d).

15. The method of performing an off-gray balance calibration of a printing system according to claim 14, wherein the standard gamut associated with the standard gamut mode is shifted along one or more gamut axes to generate the non-standard gamut.

16. The method of performing an off-gray balance calibration of a printing system according to claim 15, wherein the standard gamut is shifted by a predetermined axis of constant hue.

17. A method of printing an image on a printing system, the printing system including an operator selectable non-standard gamut mode of operation associated with an off-gray balance calibration of the printing system and a standard gamut mode of operation associated with a gray balance calibration of the printing system, the method comprising:
an operator selectably placing the printing system in the non-standard gamut mode of operation; and
the printing system printing image data associated with an image source while operating in the non-standard gamut mode of operation,
wherein the printing system accesses off-gray balance calibration data to process the image data, the off-gray balance calibration data generated by a method comprising:
a) the printing system selectably operating in the non-standard gamut mode;
b) an operator modifying one or more setpoints for one or more process parameters associated with modifying the gamut of the printing system associated with the standard gamut mode of operation, the process parameters related to a DMA (Developed Mass per unit Area) of one or more colorants associated with the printing system;
c) the printing system printing a color sample set including a plurality of patches representing the gamut associated with the operator modified one or more setpoints for the one or more process parameters associated with modifying the gamut;
d) the printing system generating one or more color look-up tables associated with the operator modified one or more setpoints for the one or more process parameters, and the printing system storing a set of measured color space values associated with a subset of the printed plurality of patches associated with substantially equivalent process values of colorants associated with the printing system;
e) repeating steps b)-d), if necessary, until a final color sample set is selected by the user, the final color sample set associated with a final one or more color look-up tables and a final set of measured color space values; and
f) the printing system associating the final one or more color look-up tables and the final set of stored measured color space values with the non-standard gamut mode, the final one or more color look-up tables associated with processing image data to be printed using the non-standard gamut.

18. The method of printing an image according to claim 17, wherein a user interface is configured to perform at least one of receiving text data, parsing text data, selecting an operating mode, controlling the operation of the printing system, selecting a color rendition dictionary, and altering or modifying setpoints.

19. The method of printing an image according to claim 17, wherein the one or more setpoints include process parameters which regulate operational hardware associated with the printing system.

20. The method of printing an image according to claim 19, wherein the one or more setpoints include one or more of a photoreceptor charged voltage, a photoreceptor discharge voltage, toner concentration, donor roll voltage and magnetic roll voltage.

21. The method of printing an image according to claim 17, wherein the image source includes at least one of color data, pixel data, scanner image data, digital camera data, video data and fax data.

22. The method of printing an image according to claim 17, wherein the printing system includes an intermediate photoreceptor member upon which colorants are deposited and subsequently transferred from the photoreceptor member to a media.

23. The method of printing an image according to claim 17, wherein the colorants include one of toner and ink including any combination of magenta, cyan, yellow and black.

24. The method of printing an image according to claim 17, wherein the non-standard output color gamut includes a shifting of the standard output color gamut to a region including colors outside the standard output color gamut.
